(19) United States
(12) Patent Application Publication
(10) Pub. No.: US 2002/0075237 A1
(43) Pub. Date: Jun. 20, 2002

(54) Keyboard structure equipped with output device

(76) Inventor: Chin-Wen Chou, Taipei (TW)

Correspondence Address: BACON & THOMAS, 4th Floor, 625 Slaters Lane, Alexandria, VA, 22314, US

(21) Appl. No.: 09/736,217

(22) Filed: Dec. 15, 2000

(51) Int. Cl. G09G 5/00

(52) U.S. Cl. 345/168; 345/156

(57) ABSTRACT

A keyboard structure equipped with output device connects with a computer and is capable of executing and output text or image files. The keyboard structure includes a keyboard and a small output device disposed at a selected location in the keyboard. The keyboard has a signal transmission unit linking to the computer. When a confirmation execution command is entered on the keyboard, the computer immediately sends output text or image file being selected to the small output device for printing on the paper which may include label (barcode, POS), document filing labels (text, patterns, marks), small size photos (close-up picture), MEMO, message, telephone numbers and the like.

### BACKGROUND OF THE INVENTION

This invention relates to keyboard structure that equips with output device and particularly a keyboard structure which includes a small output device for users to output printed labels (barcode, Point-of-Sales, POS), document filing labels (text, patterns, marks), small size photos (close-up picture), MEMO, message, telephone numbers and the like.

Nowadays computer users usually use keyboard or mouse to enter operation commands for performing text document or image process. After the process, if printed output is desired, users may use the keyboard or mouse to select print function, then computer will send the requested file to the printer for printing the output on the paper. However the printer usually has a large size and takes a lot of space and is quite heavy, it is not portable and is not easy for users to carry around for field activity use. Most printers now available in the market place are for desktop utilization.

Recently some producers have developed and introduced stocking device which is a hand-held computer coupled with printer. People who take inventory work at the field may input merchandise quantity on the stocking device and print out result report directly or to print stocking receipt whenever desired. This type of stocking device mostly can print only simple characters and numbers. It cannot print more sophisticated data and does not fully meet users' requirements.

### SUMMARY OF THE INVENTION

In view of the foregoing disadvantages, it is therefore an object of this invention to provide a keyboard structure quipped with a small output device (printer) that may save space and may enable users to enter input whenever needed, and may concurrently print labels (barcode, POS), document filing labels (text, patterns, marks), small size photos (close-up picture), MEMO, message, telephone numbers and the like, and saves space that might otherwise require for an ordinary printer, and also saves machine warm up time during initial power on.

Another object of this invention is to employs parallel characteristics of Universal Serial Bus (USB) to enable the keyboard and small output device to operate independently. Each has its own driver program, and does not affect the original design and characteristics of the keyboard and small output device.

A further object of this invention is to provide high portability to enable users to carry easily for field activity use.

In order to achieve aforesaid objects, the keyboard structure according to this invention includes a keyboard and a small output device located in the keyboard at a selected position. The keyboard structure has a signal transmission element linking to a computer. When a confirming execution command is entered from the keyboard, the computer immediately outputs the text or image file to the small output device for printing out on the paper.

### BRIEF DESCRIPTION OF THE DRAWINGS

The invention, as well as its many advantages, may be further understood by the following detailed description and drawings, in which:

FIG. 1 is a perspective view of this invention.

FIG. 2 is a side view of this invention.

FIG. 3 is a top view of this invention.

### DESCRIPTION OF THE PREFERRED EMBODIMENTS

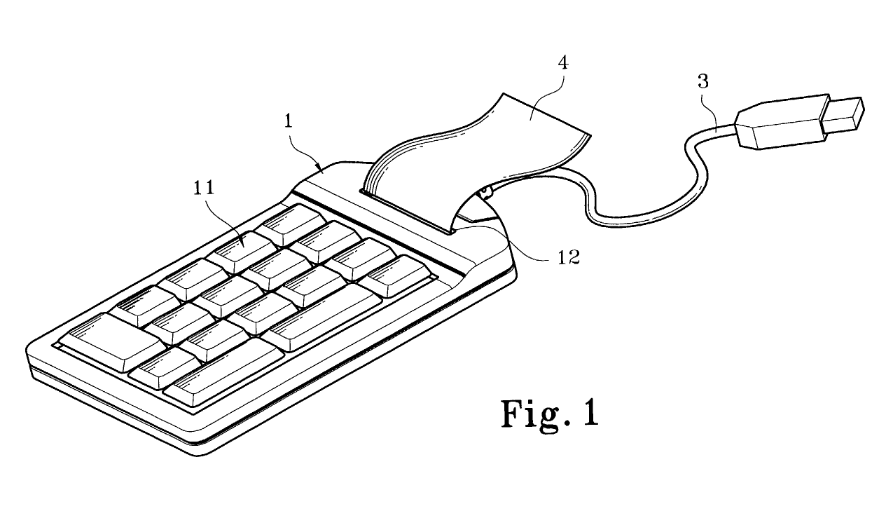

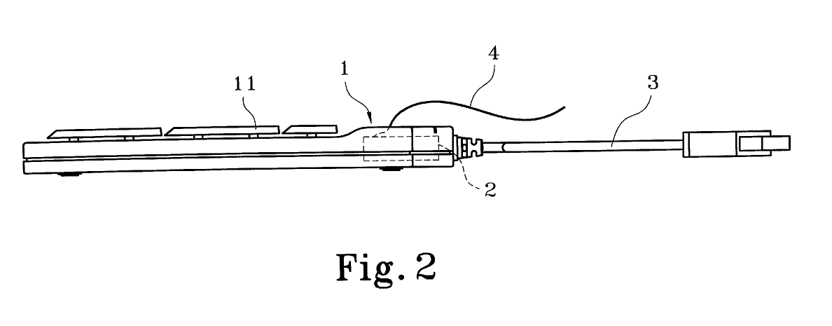

Referring to FIGS. 1 and 2, the keyboard structure according to this invention mainly to couple an USB equipped keyboard 1 with a small output device 2 for users to use the output device 2 to print label (barcode, POS), document filing labels (text, patterns, marks), small size photos (close-up picture), MEMO, message, telephone numbers and the like.

The keyboard 1 may be, but not limit to, a keypad or an ordinary large size keyboard. Inside the keyboard, there is a small output device 2 disposed at a selected location which is connected to a computer (not shown in the figures) through a signal transmission element 3. Using the parallel characteristics of USB feature, the keyboard 1 and small output device 2 may function independently. Each has its own driver program and does not affect the original design and characteristics of the keyboard 1 and small output device 2.

Furthermore, said small output device 2 is a printer which may be, but not limit to, a laser printer, inkjet printer, matrix dot printer or the like, either color or monochrome type. Users may select any one of such printers desired to print labels, marks, patterns (image), document filing labels (text, patterns, marks), small size photos (close-up picture), MEMO, message, telephone numbers and the like.

The output paper 4 used in the small output device 2 may be, but not limit to, a roll of blank paper, a roll of adhesive label paper, or a roll of photo paper, or the like.

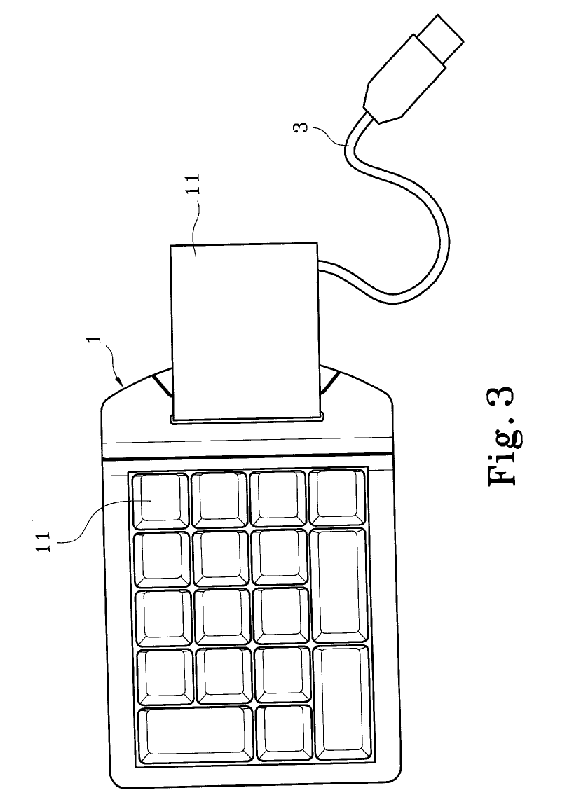

Referring to FIGS. 1, 2 and 3, when this invention is in use, an user may enter data from the key sets 11 located on the keyboard 1, or enter execution confirmation commends from the keyboard 1, computer will immediately send the text or image file which user requests to the small output device 2 for printing on the roll of blank paper or adhesive label paper or photo paper. Once the printing is finished, user may detach the printout paper from the output device 2.

By coupling the keyboard 1 and small output device 2, a lot of space may be saved. And users may key in printing request whenever desired to get the printout of the label (barcode, POS), document filing labels (text, patterns, marks), small size photos (close up picture), MEMO, message, telephone numbers and the like. It also saves the space that might otherwise need for an ordinary printer and the machine warm up time.

Furthermore, a paper cutter may be provided at the paper exit slot 12 of the keyboard 1 to facilitate printout paper detachment.

What is claimed is:

1. A keyboard structure equipped with an output device linking with a computer for executing output text or image files, comprising:
a keyboard having a signal transmission element connecting with the computer; and
a small output device disposed inside the keyboard at a selected location;
wherein upon the keyboard receiving an input confirmation commands for execution, the computer immediately outputs selected text or image files to the small output device for printing on the paper.

2. The keyboard structure of claim 1, wherein the keyboard is selectively a keypad or an ordinary large size keyboard.

3. The keyboard structure of claim 1, wherein the small output device is a printer.

4. The keyboard structure of claim 3, wherein the printer is a color or monochrome type printer selected from the group consisting of laser printer, inkjet printer, or matrix dot printer

5. The keyboard structure of claim 1, wherein the small output device uses output paper which is selected from the group consisting of rolled blank paper, rolled adhesive label paper, or rolled photo paper.

6. The keyboard structure of claim 1, wherein the keyboard has a paper exit slot which has an edge equipped with a paper cutter.

7. The keyboard structure of claim 1, wherein the keyboard and small output device operates independently by employing parallel characteristics of Universal Serial Bus and each has an independent driver program without affecting original design and characteristics thereof.
